(19) United States
(12) Patent Application Publication
(10) Pub. No.: US 2004/0082464 A1
(43) Pub. Date: Apr. 29, 2004

(54) Complex polymerization catalysts for the homopolymerization of ethylene and for the copolymerization of ethylene

(76) Inventors: Anna Maria Romano, Novara (IT); Manuela Grande, Vercelli (IT); Roberto Santi, Novara (IT); Antonio Proto, Novara (IT); Anna Sommazzi, Santa Margherita Ligure-Genova (IT)

Correspondence Address: Oblon Spivak McClelland, Maier & Neustadt, Fourth Floor, 1755 Jefferson Davis Highway, Arlington, VA, 22202, US

(21) Appl. No.: 10/239,207

(22) PCT Filed: Mar. 19, 2001
(86) PCT No.: PCT/EP01/03023

(30) Foreign Application Priority Data
Mar. 31, 2000 (IT) MI2000A000677
Mar. 31, 2000 (IT) MI2000A000678
Mar. 31, 2000 (IT) MI2000A000679

(51) Int. Cl. C07F 15/00; B01J 31/00

(52) U.S. Cl. 502/162; 548/101

(57) ABSTRACT

Complex catalysts based on a metal of group VIII complexed with suitable ligands, particularly active in the homopolymerization of ethylene and in its copolymerization with another unsaturated monomer of the vinylic and acrylic type.

The present invention relates to complex polymerization catalysts, their preparation and their use in the homopolymerization of ethylene and in the copolymerization of ethylene with another unsaturated monomer in the production of high molecular weight polymers.

Ethylene, and alpha-olefins in general, are traditionally polymerized by means of Ziegler type catalysts generally consisting of a hydride, or organometallic compound, of elements of groups I to III of the periodic table and a compound of a transition metal belonging to groups IV to VI of the periodic table.

Non-traditional catalysts based on various nickel complexes, capable of polymerizing olefins, described for example in patent application DE-3,228,865 and EP-137,389, are also described in patent literature.

Patent application IT-20186 A/89 describes a group of catalysts consisting of nickel complexes with phosphorate derivatives bound to a polystyrene carrier.

New catalysts have now been found, based on a metal of group VIII complexed with suitable ligands, particularly active in the homopolymerization of ethylene and in its copolymerization with another unsaturated monomer of the vinylic and acrylic type.

The complex catalysts, object of the present invention, for the homopolymerization of ethylene and for the copolymerization of ethylene with another unsaturated monomer are characterized in that they have one of the following general formulae:

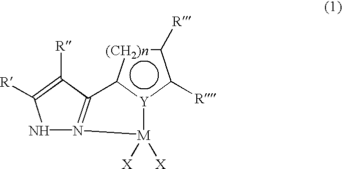

wherein

M is an element of Group VIII, preferably selected from Ni, Co, Fe, Ru, Pd,

X is a halogen, preferably selected from Br and Cl,

Y is selected from N, O and S

R′ and R″, the same or different, are selected from hydrogen, linear or branched alkyl, cycloalkyl and aryl groups, said groups, containing from 1 to 10 carbon atoms, being optionally halogenated, preferably with fluorine,

R′″, R″″, the same or different, are selected from hydrogen and aryl groups or are bound together to form a condensed benzene ring, said aryl groups or said condensed benzene ring being optionally substituted with linear or branched alkyl groups containing from 1 to 10 carbon atoms,

n is an integer having the value of 1 or 2;

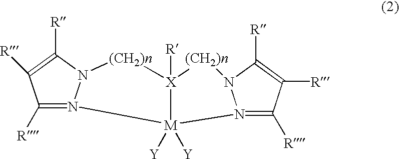

wherein

M is an element of Group VIII, preferably selected from Ni, Co, Fe, Ru, Pd,

Y is a halogen, preferably Br,

X is selected from N, O and S

R′, R″, R′″, R″″, the same or different, are selected from hydrogen, linear or branched alkyl, cycloalkyl and aryl groups, said groups, containing from 1 to 10 carbon atoms, being optionally halogenated,

n is an integer ranging from 1 to 3;

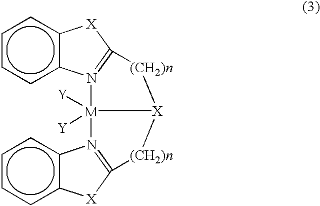

wherein

M is an element of Group VIII, preferably selected from Ni, Co, Fe, Ru, Pd,

Y is a halogen, preferably Br,

X is selected from NH, O and S

n is an integer ranging from 1 to 3.

When R′, R″, R′″ and/or R″″ are aryl groups, they are preferably selected from phenyl, biphenyl, naphthyl and anthracenyl.

Said aryl groups, in the formula (2), can optionally be substituted with linear or branched alkyl groups containing from 1 to 10 carbon atoms.

The process for the preparation of the catalyst described above by formula (1) is characterized by the use of a halide of an anhydrous metal (II) of Group VIII, diluting said halide in a suitable distilled solvent and adding a ligand, having the general formula:

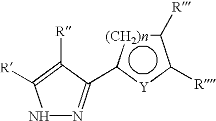

wherein Y, R′, R″, R′″ and R″″ have the same values specified for the general formula (1) of the catalyst described above,

in an equivalent quantity with respect to the anhydrous metal, and finally isolating the complex of the metal of Group VIII by filtration or by evaporation of the solvent and subsequent drying.

The process for the preparation of the catalyst described above by formula (2) is characterized by the use of a halide of an anhydrous metal (II) of Group VIII, diluting said halide in a suitable distilled solvent and adding a ligand, having the general formula:

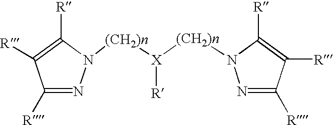

wherein X, R′, R″, R′″ and R″″ have the same values specified for the general formula (2) of the catalyst described above,

in an equivalent quantity with respect to the anhydrous metal, and finally isolating the complex of the metal of Group VIII by filtration or by evaporation of the solvent and subsequent drying.

The process for the preparation of the catalyst described above by formula (3) is characterized by the use of a halide of an anhydrous metal (II) of Group VIII, diluting said halide in a suitable distilled solvent and adding a ligand, having the general formula:

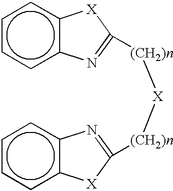

wherein X and n have the same values specified for the general formula (3) of the catalyst described above,

in an equivalent quantity with respect to the anhydrous metal, and finally isolating the complex of the metal of Group VIII by filtration or by evaporation of the solvent and subsequent drying.

The catalysts of the present invention are active in the homopolymerization of ethylene and in the copolymerization of ethylene with another unsaturated monomer.

The expression “another unsaturated monomer”, as used in the present invention, refers to another alphaolefin or an unsaturated monomer of the acrylic or vinylic type.

Examples of these unsaturated monomers copolymerizable with ethylene are: propylene, alkyl esters (C₁-C₁₂) of acrylic or methacrylic acid, such as methyl and ethyl acrylate and methacrylate, vinyl acetate, acrylonitrile and styrene.

The polymerization or copolymerization of ethylene can be carried out with the normal polymerization techniques: however in the preferred embodiment the technique in suspension of an organic-liquid diluent, normally selected from aliphatic, cycloaliphatic and aromatic hydrocarbons, such as for example hexane and toluene, is adopted.

Ethylene, or a mixture of ethylene and another unsaturated monomer, is conveniently fed to said liquid reaction medium, operating at a temperature ranging from 10 to 100° C., preferably from room temperature (20-25° C.) to 60° C., and at a pressure ranging from atmospheric pressure to 100 bars.

Under these conditions, polymers and copolymers of ethylene are obtained in the solid state, with a molecular weight depending on the polymerization conditions, useful for practical purposes.

Some experimental examples are provided for a better illustration of the present invention.

### EXAMPLES 1-16

The examples for the preparation of the catalyst with formula (1) are carried out according to the following general synthesis procedure.

The desired quantity of an anhydrous nickel (II) halide (NiCl₂, NiBr₂.DME or NiI₂) is charged into a test-tube under argon, it is diluted with a suitable distilled, anhydrous solvent and, finally, the desired ligand is added in an equivalent quantity with respect to the metal. The complex is isolated either by filtration or by evaporation of the solvent and subsequent drying. It is characterized by means of ¹H NMR and mass spectrometry.

### Example 1

a) Synthesis of 1-(2-pyridine)-4,4,4-trifluoromethyl-butane-1,3-dione.

25 ml of 1-acetyl-pyridine (0.22 moles) are added dropwise, in about 4 hours, to a suspension of 53 ml of ethyl trifluoroacetate (0.44 moles) and 17.6 g of NaH 60% (0.44 moles) in 350 ml of anhydrous ethyl ether. A further 300 ml of anhydrous ethyl ether are added to keep the reaction mass fluid. The mixture is then refluxed for 9 hours and, after this period, 40 ml of ethanol are slowly added dropwise to destroy the excess NaH and the mixture is filtered on filter paper. The reaction mixture is poured into a 1 liter beaker containing 400 g of ice and 100 ml of glacial AcOH and the mixture is maintained under stirring for the whole night. The two phases are subsequently separated and the aqueous phase is washed with ethyl ether (3×200 ml), whereas the ether phase, after being washed with NaHCO₃ until neutrality and again with water, is dried on Na₂SO₄ and finally evaporated from the solvent. 32.5 g of product are obtained, which, upon NMR analysis, proves to have a 93% purity (yield: 68%).

¹H NMR (in CDCl₃, ppm): 9.85 (1H, m), 8.31 (1H, m), 7.91 (1H, m), 7.60 (1H, m), 2.15 (2H, s).

b) Synthesis of 3-trifluoromethyl-5-pyridine-pyrazole (I)

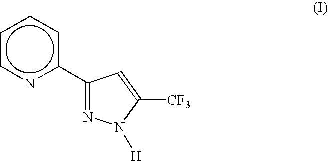

43 ml of hydrazine hydrate (0.84 moles) diluted with 20 ml of water with exothermy are slowly added dropwise to a solution of 32.5 g of 1-(2-pyridine)-4,4,4-tri-fluoromethyl-butane-1,3-dione (0.139 moles) dissolved in 80 ml of ethanol. The mixture is refluxed for 1 hour and, after cooling, is extracted with ethyl ether (100 ml for 10 times). The ether phase, washed with water (150 ml for 3 times) to eliminate the excess hydrazine, dried on Na₂SO₄ and finally evaporated from the solvent, provides 26 g of raw material, which is crystallized with 200 ml of warm toluene. The white crystals are filtered, washed with petroleum ether and dried with a mechanical pump. 11.6 g of a light pink solid are thus obtained.

¹H NMR (light pink solid, in (CD₃)₂CO, ppm): 8.5 (1H, dd), 7.95 (1H, dd), 7.80 (1H, m), 7.30 (1H, m), 3.45 (2H, s), IR (in nujol): 3360 cm⁻¹ M.S.=159 m/z m.p.=139-40° C.

### Example 2

Synthesis of [3-trifluoromethyl-5-pyridine-pyrazole]NiBr₂ (II):

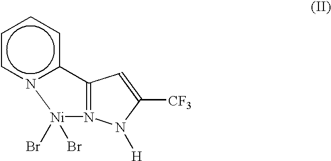

0.616 g of anhydrous NiBr₂.DME (0.002 moles) suspended in 50 ml of anhydrous DME are charged under argon into a 150 ml test-tube. 0.428 g of 3-trifluoromethyl-5-pyridine-pyrazole (0.002 moles) are added. There is an immediate colour-change from beige to green. After a night, the solvent is evaporated, the green residue is washed with methylene chloride and dried with a pump, obtaining 0.160 g of green complex (yield: 18%).

¹H NMR (in DMSO-d₆, ppm): 8.5 (1H, m), 7.84 (2H, m), 7.26 (1H, m), 7.19 (1H, s).

### Example 3

23 mg of the complex (II) (MW=430; 5.3·10⁻⁵ moles) are charged under argon into a 100 ml four-necked flask. The complex is dissolved in 60 ml of toluene. 1 ml of triisobutylaluminum 1 M (TIBAL; 20 eq) is added. The green solution put under ethylene becomes golden yellow. It is kept at room temperature for 2 hours and is heated to 45° C. for 2 hours. After quenching the reaction with ethanol and H₂SO₄ 10%, the product is extracted with methylene chloride, and, after evaporation of the solvent, provides 0.3 g of solid.

Activity=5600 g PE/Ni mole

### Example 4

10 mg of the complex (II) in 30 ml of toluene (MW=430; 2.32·10⁻⁵ moles) are charged under argon into a 100 ml three-necked flask. 6 ml of TEA 1 M (500 eq) are added. The green solution put under ethylene becomes golden yellow. It is kept at room temperature for 2 hours and is heated to 65° C. for 2 hours. After quenching the reaction with ethanol and H₂SO₄ 10%, the product is extracted with methylene chloride, and, after evaporation of the solvent, provides 0.05 g of solid.

Activity=4300 g PE/Ni mole

### Example 5

21 mg of (II) (MW=430; 4.87·10⁻⁵ moles) are charged under argon into a 100 ml four-necked flask equipped with a cooler. The complex is suspended in 60 ml of CH₂Cl₂ (green solution). 1.7 ml of MAO 1.57 M (55 eq) are added. The green solution put under ethylene becomes golden yellow. It is kept at room temperature for 2 hours and is heated to 65° C. for 2 hours. After quenching the reaction with ethanol and H₂SO₄ 10%, the product is extracted with methylene chloride, and, after evaporation of the solvent, provides. 0.41 g of solid.

Activity=8400 g PE/Ni mole

### Example 6

21 mg of (II) (MW 430; 4.8·10⁻⁵ moles) are charged under argon into a 100 ml four-necked flask equipped with a cooler. The complex is dissolved in 60 ml of toluene. 2 ml of MAO 1.45 M (65 eq) are added. The green solution put under ethylene becomes golden yellow. It is kept at room temperature for 2 hours and is heated to 65° C. for 2 hours. After quenching the reaction with ethanol and H₂SO₄ 10%, the product is extracted with methylene chloride, and, after evaporation of the solvent, provides 1.06 g of solid.

Activity=21700 g PE/Ni mole

### Example 7

7.3 mg of (II) (MW=430; 1.711·10⁻⁵ moles) are charged under argon into a 250 ml four-necked flask equipped with a cooler. The complex is dissolved in 60 ml of toluene at 0° C. under ethylene. 1 ml of MAO 1.57 M (100 eq) is added. The solution is kept at 0° C. for 2 hours and at room temperature for 12 hours. After quenching the reaction with methanol and HCl 10%, the product is extracted with methylene chloride, and, after evaporation of the solvent, provides 0.671 g of polymer.

Activity=39200 g PE/Ni mole Tm=130.9° C. (determined by means of DSC-heating rate=10° C./min). N=4 branchings×1000 C atoms (determined by means of ¹H and ¹³C NMR spectroscopy).

### Example 8

a) Synthesis of 1-(2-benzofuranyl)-4,4,4-trifluoromethyl-butane-1,3-dione

35.7 ml of 2-acetyl benzofuran (0.30 moles) are added dropwise, in about 4 hours, to a suspension of 35.7 ml of ethyl trifluoroacetate (0.60 moles) and 24.0 g of NaH 60% (0.60 moles) in 500 ml of anhydrous ethyl ether. A further 500 ml of anhydrous ethyl ether are added to keep the reaction mass fluid. The mixture is refluxed for 1 hour and, after this period, 50 ml of ethanol are slowly added dropwise to destroy the excess NaH. The reaction mixture is poured into a 1 liter beaker containing 500 g of ice and water and HCl is added until pH=5. The two phases are subsequently separated and the aqueous phase is washed with ethyl ether (3×200 ml), whereas the ether phase, after being washed with NaHCO₃ until neutrality, is washed again with water and dried on Na₂SO₄ and finally evaporated from the solvent. 26.4 g of product are obtained, which, from NMR proves to correspond to a mixture of keto-enolic tautomers (yield: 42%).

¹H NMR (in CD₃COCD₃, ppm): 7.66 (2H, m), 7.55 (2H, m), 6.20 (1H, s), 3.20 (2H, s).

b) Synthesis of 3-trifluoromethyl-5-benzofuranyl pyrazole (III)

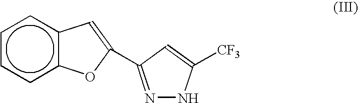

20 g of hydrazine hydrate (0.4 moles) in water, are slowly added dropwise to a solution containing 26 ml of 1-(2-benzofuranyl)-4,4,4-trifluoromethylbutane-1,3-dione (0.128 moles) in 500 ml of ethyl ether, with a slight development of heat. At the end of the addition, the mixture is refluxed for 1 hour. The two phases are subsequently separated and the aqueous phase is washed with ethyl ether (6×200 ml), whereas the organic phase, after being washed with NaHCO₃ until neutrality and again with water, is dried on Na₂SO₄ and finally evaporated from the solvent. 16.0 g of solid are obtained, which, from mass spectrometry and GC-mass analysis appears to be the desired product.

¹H NMR (in CD₃COCD₃, ppm): 7.46 (2H, q), 7.25 (2H, q), 6.92 (1H, s), 6.32 (1H, s). mass: 252 (molecular ion).

### Example 9

Synthesis of [3-trifluoromethyl-benzofuranyl pyrazole]NiBr₂ (IV)

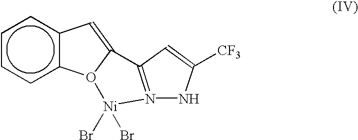

0.828 g of 3-trifluoromethyl-benzofuranyl pyrazole (3.4 mmoles) are added to a purple solution containing 1.05 g of NiBr₂.DME (3.4 mmoles) in 100 ml of distilled and anhydrous THF, with the formation of a yellow precipitate. The solid is filtered, washed with heptane and dried. 1.403 g of complex are obtained (yield:88%). Mass: 471 (molecular ion).

### Example 10

3.5 mg of (IV) (MW=470; 0.74·10⁻⁶ moles) are placed under argon in a 100 ml four-necked flask. The complex is dissolved in 30 ml of toluene and 5 ml of MAO 1.57 M (1050 eq) are added. After treating the reaction with methanol and HCl 10%, the mixture is extracted with methylene chloride, and, after evaporation of the solvent, provides 0.380 g of polymer.

Activity=51028 g PE/Ni mole Tm=85.2° C. (determined by means of DSC-heating rate=10° C./min). N=31 branchings×1000 C atoms (determined by means of ¹H and ¹³C NMR spectroscopy).

### Example 11

3.5 mg of (IV) (MW=470; 7.4·10⁻⁶ moles) are placed under argon in a 250 ml four-necked flask. The complex is dissolved in 120 ml of toluene (yellow solution). 5 ml of MAO 1.57 M (1000 eq) are added. The green solution put under ethylene darkens. It is kept at room temperature for 2 hours and is heated to 45° C. for. 2 hours. After treating the reaction with methanol and HCl 10%, the mixture is extracted with methylene chloride, and, after evaporation of the solvent, provides 0.298 g of polymer.

Activity=40017 g PE/Ni mole

### Example 12

5 mg of (IV) (MW=470; 1.06·10⁻⁵ moles) are placed under argon in a 100 ml four-necked flask. The complex is dissolved in 30 ml of toluene (yellow solution) and 0.65 ml of MAO 1.57 M (100 eq) are added. The yellow solution put under ethylene becomes golden. It is heated to 45° C. for 2 hours and is kept at room temperature for 2 hours. After treating the reaction with methanol and HCl 10%, the mixture is extracted with methylene chloride, and, after evaporation of the solvent, provides 0.36 g of polymer.

Activity=338.40 g PE/Ni mole

### Example 13

a) Synthesis of 1-(2-thiophenyl)-4,4,4-trifluoromethyl-butane-1,3-dione

38.5 ml of 2-acetylthiophene (0.30 moles) are added dropwise, in about 4 hours, to a suspension of 35.7 ml of ethyl trifluoroacetate (0.60 moles) and 24.0 g of NaH 60% (0.60 moles) in 500 ml of anhydrous ethyl ether. A further 500 ml of anhydrous ethyl ether are added to keep the reaction mass fluid. The mixture is refluxed for 1 hour and, after this period, 50 ml of ethanol are slowly added dropwise to destroy the excess NaH. The reaction mixture is poured into a 1 liter beaker containing 500 g of ice and water and HCl is added until pH=5. The two phases are subsequently separated and the aqueous phase is washed with ethyl ether (3×200 ml), whereas the ether phase, after being washed with NaHCO₃ until neutrality, is washed again with water and dried on Na₂SO₄ and finally evaporated from the solvent. 60 g of raw product are obtained, which is purified by reaction with 40 g of Cu(OCOCH₃)₂ (0.198 moles) in 350 ml of hot water and 100 ml of methanol. A green precipitate is immediately formed, which is filtered, washed with petroleum ether and dried with a pump. The copper β-diketonate complex (57 g) is treated with 500 ml of H₂SO₄ 10% and, after stirring for an hour, extracted with ethyl ether (200 ml×3 times) and dried on Na₂SO₄. After evaporation of the solvent, 47 g of clean product are obtained (yield: 71%).

¹H NMR (in CDCl₃, ppm): 8.25 (1H, m), 8.10 (1H, m), 8.01 (1H, m), 7.32 (1H, m), 6.86 (1H, s), 6.48 (1H, s), 3.42 (1H, s).

b) Synthesis of 3-trifluoro methyl-5-thiophenylpyrazole (V)

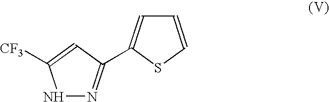

60 ml of hydrazine (0.6 moles) are slowly added dropwise to a solution containing 45 ml of 1-(2-thiophenyl)-4,4,4-trifluoromethyl-butane-1,3-dione (0.02 moles) in 500 ml of ethanol, with a slight development of heat. At the end of the addition, the mixture is refluxed for 1 hour. The two phases are subsequently separated and the aqueous phase is washed with methylene chloride (6×200 ml), whereas the organic phase, after being washed with an aqueous saturated solution of NaHCO₃ until neutrality, is washed again with water and dried on Na₂SO₄ and finally evaporated from the solvent. 29.25 g of product are obtained (yield: 78%).

¹H NMR (in CDCl₃, ppm): 13.8 (1H, broad, s), 7.25 (2H, m), 7.06 (1H, dd), 6.70 (1H, s),; m.p.=121° C.

### Example 14

Synthesis of [3-trifluoromethyl-thiophenyl pyrazole]NiCl₂ (VI)

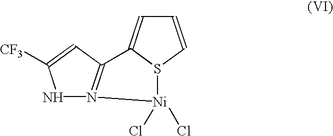

1.151 g of 3-trifluoromethyl-thiophenyl pyrazole (5 mmoles) are added under argon to a solution containing 0.651 g of anhydrous NiCl₂ (5 mmoles) in 100 ml of distilled and anhydrous DME. The solvent is evaporated, methylene chloride is added and the yellow solid is filtered and dried. 0.603 g of complex are obtained (yield: 23%)

mass=347 (molecular ion)

### Example 15

10.8 mg of (VI) (MW 347; 3.11·10⁻⁵ moles) are charged under argon into a 100 ml four-necked flask. The complex is dissolved in 30 ml of toluene and 1 ml of MAO 1.57 M (50 eq) are added. The green solution put under ethylene becomes golden yellow. It is heated to 65° C. for 2 hours and is kept at room temperature for 2 hours. After quenching the reaction with ethanol and H₂SO₄ 10%, the product is extracted with methylene chloride, and, after evaporation of the solvent, provides 0.170 g of brown wax.

Activity=5500 g PE/Ni mole

### Example 16

10 mg of (VI) (MW=347; 2.9·10⁻⁵ moles) are charged under argon into a 100 ml four-necked flask. The complex is dissolved in 30 ml of toluene. 10 ml of MAO 1.57 M (550 eq) are added. The green solution put under ethylene becomes golden yellow. It is kept at room temperature for 2 hours and is heated to 65° C. for 2 hours. After quenching the reaction with ethanol and H₂SO₄ 10%, the product is extracted with methylene chloride, and, after evaporation of the solvent, provides 0.28 g of waxy solid.

Activity=9700 g PE/Ni mole Tm=112.5° C. (determined by means of DSC-heating rate=10° C./min). N 12 branchings×1000 C atoms (determined by means of ¹H and ¹³C NMR spectroscopy).

### EXAMPLES 17-25

The examples for the preparation of the catalyst with formula (2) are carried out according to the following general synthesis procedure.

The desired quantity of an anhydrous nickel (II) halide (NiCl₂, NiBr₂.DME or NiI₂) is charged into a test-tube under argon, it is diluted with a suitable distilled, anhydrous solvent and, finally, the desired ligand is added in an equivalent quantity with respect to the metal. The complex is isolated either by filtration or by evaporation of the solvent and subsequent drying. It is characterized by means of ¹H NMR and mass spectrometry.

### Example 17

Synthesis of bis[2-(3,5-dimethyl-1-pyrazolyl)ethyl]amine (VII)

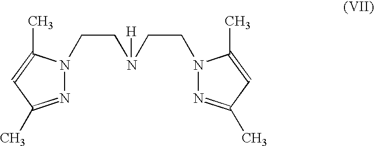

500 ml of anhydrous DMF in which 30 g of NaH 60% (0.75 moles) are suspended, are charged under argon into a 1 liter three-necked flask, equipped with a cooler, drip funnel and thermometer. A solution of 48 g of 3,5-dimethyl pyrazole (0.5 moles) dissolved in 100 ml of anhydrous DMF are slowly added dropwise to this suspension. The mixture is kept at 60° C. for 2 hours and 44.62 g of (ClCH₂CH₂)NH.HCl (0.25 moles) are added in small portions and under argon to the solution obtained, with the development of hydrogen. After 30 hours at 60° C., the mixture is cooled and the NaCl is filtered. The solvent is evaporated and 50 ml of methanol are added to the residue, which is subsequently poured into 2.5 l of hot water at 90° C. After cooling, the mixture is filtered and dried under vacuum for a night. After this period, the beige solid obtained, which still contains crystallization water (solid mass: m/z=297) becomes liquid (m/z=261). 12 g of product are obtained (yield=19.2%)

¹H NMR (in CDCl₃, ppm): 5.64 (1H, s), 3.93 (2H, t), 2.90 (2H, t), 2.17 (6H, s), 2.13 (6H, s).

### Example 18

Synthesis of bis[2-(3,5-dimethyl-1-pyrazolyl)ethyl]ami NiBr₂(VIII)

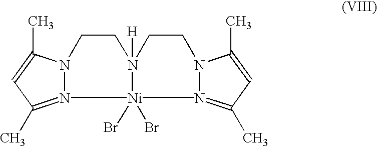

1.407 g of bis[2-(3,5-dimethyl-1-pyrazolyl)ethyl]amine (5.39 mmoles) in 70 ml of anhydrous DME are charged under argon into a 150 ml test-tube and 1.664 g of NiBr₂.DME (5.39 mmoles) are added, with an immediate colour-change from light yellow to grass green. After a night, the mixture is filtered, washed and dried with a mechanical pump. 2.202 g of light green raw product are thus obtained which in mass spectroscopy reveals a molecular peak of 702 attributed to [bis[2-3,5-dimethyl-1-pyrazolyl)ethyl]amine NiBr₂]. After crystallization with acetonitrile, 0.5 g of grass green complex are obtained, which upon elemental analysis proves to have a molar ratio Ni/Br=½.

¹H NMR (in CD₃CN, ppm): 7.2 (2H, s), 6.75 (12H, s), 6.35 (2H, t), 6.10 (2H, t). IR (in nujol): 3200 cm⁻¹.

### Example 19

24 mg of (VIII) (MW=479; 5.0·10⁻⁵ moles) are charged under argon into a 100 ml four-necked flask. The complex is dissolved in 60 ml of toluene (green solution). 1 ml of triisobutylaluminum 1 M (TIBA; 20 eq) is added. The green solution put under ethylene becomes golden yellow. It is kept at room temperature for 2 hours and is heated to 45° C. for 2 hours. After quenching the reaction with ethanol and H₂SO₄ 10%, the product is extracted with methylene chloride, and, after evaporation of the solvent, provides 0.250 g of brown oil.

Activity=5000 g PE/Ni mole

### Example 20

24 mg of (VIII) (MW=479; 5.0·10⁻⁵ moles) are charged under argon into a 100 ml four-necked flask. The complex is dissolved in 60 ml of toluene (green solution). 2 ml of MAO 1.45 M (65 eq) are added. The green solution put under ethylene becomes golden yellow. It is kept at room temperature for 2 hours and is heated to 45° C. for 2 hours. After quenching the reaction with ethanol and H₂SO₄ 10%, the product is extracted with methylene chloride, and, after evaporation of the solvent, provides 1.075 g of polymer.

Activity=21455 g PE/Ni mole

### Example 21

5.5 mg of (VIII) (MW=479; 1.1·10⁻⁵ moles) are charged under argon into a 100 ml four-necked flask. The complex is dissolved in 60 ml of toluene (green solution). 6 ml of MAO 1.57 M (800 eq) is added. The green solution put under ethylene becomes golden yellow. It is kept at room temperature for 2 hours and is heated to 45° C. for 2 hours. After quenching the reaction with ethanol and H₂SO₄ 10%, the product is extracted with methylene chloride, and, after evaporation of the solvent, provides 0.355 g of polymer.

Activity=30917 g PE/Ni mole Tm=132° C. (determined by means of DSC-heating rate=10° C./min). N=4 branchings×1000 C atoms (determined by means of ¹H and ¹³C NMR spectroscopy).

### Example 22

a) Synthesis of 1-(hydroxymethyl)-3,5-dimethylpyrazole

20.3 g of 3,5-dimethylpyrazole (0.21 moles) and 6.8. g of formaldehyde (0.23 moles) are charged into a 500 ml test-tube. The mixture is brought to 120° C. for 24 hours and is kept under stirring. 1,2-dichloroethane is then added and the mixture is left to crystallize. The crystals are filtered and dried; 20.7 g of product are obtained (yield: 79%)

¹H NMR (in CDCl₃, ppm): 8.00 (1H, s), 5.79 (1H, s), 5.37 (2H, s), 2.30 (3H, s), 2.13 (3H, s).

b) Synthesis of bis(3,5-dimethylpyrazol-1-ylmethyl)-i-propylamine (IX)

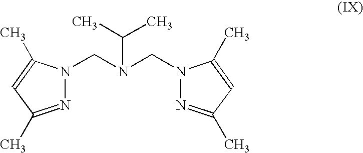

2 g of 1-(hydroxymethyl)-3,5-dimethylpyrazole (1.58 mmoles) and 0.77 ml of i-propyl amine (0.79 mmoles) dissolved in 60 ml of 1,2-dichloroethane are charged into a 100 ml one-necked flask. The mixture is kept under stirring at room temperature for 24 hours. The solvent is distilled in a rotavapor and the residue dried with a mechanical pump. 2.2 g of product are obtained (yield: 98%).

¹H ,NMR (in CDCl₃, ppm): 5.80 (2H, s), 4.79 (4H,. s), 3.15 (1H, q), 2.30 (6H, s), 1.13 (6H, d).

### Example 23

Synthesis of [bis(3,5-dimethylpyrazol-1-ylmethyl)-i-propylamine]NiBr₂ (X)

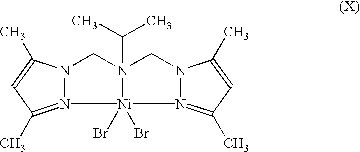

0.500 g of NiBr₂.DME (MW=308; 1.63 mmoles) are charged under argon into a 100 ml test-tube and dissolved in 60 ml of anhydrous and degassed DME. 0.446 g of ligand (MW=275; 1.63 mmoles) are added to the pink suspension, with the immediate dissolution of the NiBr₂.DME. The green solution darkens after 1 night and is evaporated from the solvent; heptane is added to the purple solid obtained, which after filtering and washing with heptane, give 0.365 g of purple complex (yield: 65%).

Mass: 413 (molecular ion).

### Example 24

14 mg of (X) (MW=413; 3.3·10⁻⁵ moles) are charged under argon into a 100 ml four-necked flask. The complex is dissolved in 30 ml of toluene (pink solution). 1 ml of MAO 1.57 M (50 eq) is added. The green solution becomes golden yellow. It is heated to 65° C. for 2 hours. After quenching the reaction with ethanol and H₂SO₄ 10%, the product is extracted with methylene chloride, and, after evaporation of the solvent, provides 0.415 g of polymer.

Activity=12245 g PE/Ni mole

### Example 25

9.8 mg of (X) (MW=490; 2·10⁻⁵ moles) are charged under argon into a 100 ml four-necked flask. The complex is suspended in 30 ml of toluene (pink solution). 12.73 ml of MAO 1.57 M (1000 eq) are added. The green solution becomes golden yellow. After 24 hours at room temperature, the reaction is quenched with ethanol and H₂SO₄ 10%, the product is extracted with methylene chloride and, after evaporation of the solvent, provides 0.559 g of polymer.

Activity=24304 g PE/Ni mole

### EXAMPLES 26-32

The examples for the preparation of the catalyst with formula (3) are carried out according to the following general synthesis procedure.

The desired quantity of an anhydrous nickel (II) halide (NiCl₂, NiBr₂.DME or NiI₂) is charged into a test-tube under argon, it is diluted with a suitable distilled, anhydrous solvent and, finally, the desired ligand is added in an equivalent quantity with respect to the metal. The complex is isolated either by filtration or by evaporation of the solvent and subsequent drying. It is characterized by means of ¹H NMR and mass spectrometry.

### Example 26

Synthesis of N,N′-bis-(2 methylene-benzoimidazole) (XI)

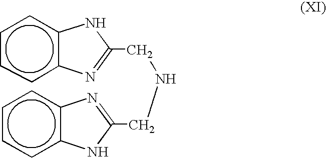

44 g of ortho-phenylenediamine (0.407 moles), 27 g of imino-diacetic acid (0.203 moles) and 250 ml of HCl 6 N are charged into a 500 ml three-necked flask equipped with a cooler. The mixture is heated to 110° C. for 72 hours. A solid is separated from the blue solution which, after filtration, weighs 54.84 g and consists of NH(CH₂C₇H₅N₂)₂-3HCl ; upon heat treatment with NH₄OH 37%, 39.75 g of white crystals are obtained (yield: 74%).

¹H NMR (in CD₃OD, ppm): 7.78 (4H, m), 7.60 (4H, m), 4.55 (4H, s). m.p.=250°-1° C.

### Example 27

Synthesis of [N,N′-bis-(2-methylene-benzoimidazole))]NiBr₂ (XII)

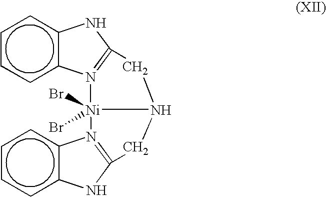

1,27 g of NiBr₂.DME (3.5 mmoles) are charged under argon into a 250 ml test-tube and are dissolved in 100 ml of distilled, anhydrous methanol. A light green solution is obtained, and upon addition of 0.961 g of N,N′-bis-(2-methylene-benzoimidazole) (3.5 mmoles) a light purple solid is separated. After 30 minutes at reflux temperature, the solvent is evaporated, heptane is added and the pink solid is filtered. After drying making use of a mechanical pump, the green complex weighs 1.03 g (yield: 59%).

Mass: 495 (molecular ion).

### Example 28

14 mg of (XII) (MW=495; 2.8·10⁻⁵ moles) are charged under argon into a 100 ml four-necked flask. The complex is dissolved in 30 ml of toluene. 1 ml of MAO 1.45 M (70 eq) is added. Upon the addition of MAO, the suspension becomes homogeneous and light green. It is kept at room temperature for 2 hours and is heated to 45° C. for 2 hours. After quenching the reaction with ethanol and H₂SO₄ 10%, the product is extracted with methylene chloride, and, after evaporation of the solvent, provides 0.170 g of polymer.

Activity=6010 g PE/Ni mole

### Example 29

14 mg of (XII) (MW=495; 2.8·10⁻⁵ moles) are charged under argon into a 100 ml four-necked flask. The complex is dissolved in 30 ml of toluene and 2 ml of MAO 1.45 M (150 eq) are added. Upon the addition of MAO, the suspension becomes homogeneous and light green. It is kept at room temperature for 2 hours and is heated to 45° C. for 2 hours. After quenching the reaction with ethanol and H₂SO₄ 10%, the product is extracted with methylene chloride, and, after evaporation of the solvent, provides 0.270 g of polymer.

Activity=9546 g PE/Ni mole

### Example 30

Synthesis of bis-(2 methylene-benzoimidazolyl)-ether (XIII)

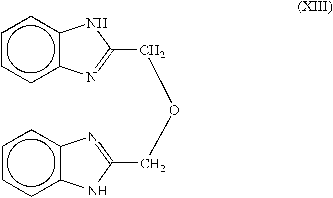

12.1 g of diglycolic acid (90 mmoles) are combined with 19.5 g of o-phenylene-diamine (0.180 mmoles) in 250 ml of HCl 4 N. The mixture is refluxed for 14 hours and subsequently neutralized by treatment with NH₄OH 37%. The white precipitate is filtered, washed with ethyl ether and, once dried, weighs 14.0 g (yield: 56%) ¹H NMR (in CD₃OD, ppm): 7.7 (4H, m), 7.15 (4H, m), 4.95 (4H, s). m.p.=295° C.

### Example 31

Synthesis of[bis-(2 methylene-benzoimidazolyl)-ether]NiBr₂(XIV)

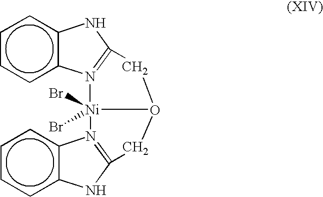

0.55 g of NiBr₂.DME (MW=308; 1.78 mmoles) are charged under argon into a 250 ml test-tube and DME is added. 0.50 g of ligand bis-(2 methylene-benzoimidazolyl)-ether (MW=278; 1.78 mmoles) are added to the salmon pink suspension. The solid is filtered and dried by means of a mechanical pump. 0.6 g of complex are obtained (yield 68%).

mass: 496 (molecular ion).

### Example 32

11.5 mg of (XIV) (MW=496; 2.31·10⁻⁵ moles) are charged under argon into a 100 ml four-necked flask. The complex is dissolved in 30 ml of toluene (yellow solution) and 1.45 ml of MAO 1.57 M (100 eq) are added. The yellow solution put under ethylene becomes golden. It is heated to 65° C. for 2 hours and is kept at room temperature for 2 hours. After quenching the reaction with ethanol and H₂SO₄ 10%, the product is extracted with methylene chloride, and, after evaporation of the solvent, provides 0.11 g of a waxy solid (LLDPE).

Activity=4744 g PE/Ni mole

1. Complex catalysts for the homopolymerization of ethylene and for the copolymerization of ethylene with another unsaturated monomer characterized in that it have have one of the following general formulae: 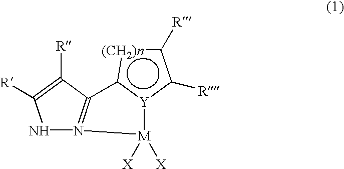
wherein:
M is an element of Group VIII,
X is a halogen,
Y is selected from N, O and S
R′ and R″, the same or different, are selected from hydrogen, linear or branched alkyl, cycloalkyl and aryl groups, said groups, containing from 1 to 10 carbon atoms, being optionally halogenated,
R′″, R″″, the same or different, are selected from hydrogen and aryl groups or are bound together to form a condensed benzene ring, said aryl groups or said condensed benzene ring being optionally substituted with linear or branched alkyl groups containing from 1 to 10 carbon atoms,
n is an integer having the value of 1 or 2; 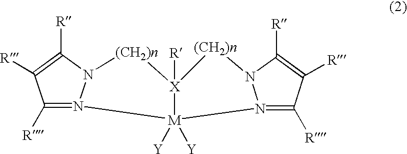
wherein
M is an element of Group VIII,
Y is a halogen,
X is selected from N, O and S
R′, R″, R′″, R″″, the same or different, are selected from hydrogen, linear or branched alkyl, cycloalkyl and aryl groups, said groups, containing from 1 to 10 carbon atoms, being optionally halogenated,
n is an integer ranging from 1 to 3; 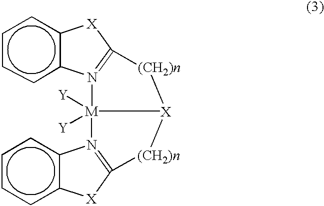
wherein
M is an element of Group VIII,
Y is a halogen,
X is selected from NH, O and S
n is an integer ranging from 1 to 3.

2. The catalyst according to claim 1, wherein the metal of Group VIII is nickel.

3. The catalyst according to claim 1, wherein the aryl group is selected from phenyl, biphenyl, naphthyl or anthracenyl.

4. The catalyst according to claim 1, where, in the formula (1), the halogen is bromine or chlorine.

5. The catalyst according to claim 1, where, in the formula (1), the linear or branched alkyl group is halogenated with fluorine.

6. The catalyst according to claims 1 and 2 having the following formula:

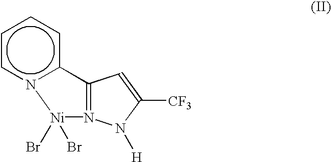

7. The catalyst according to claims 1 and 2 having the fol lowing formula:

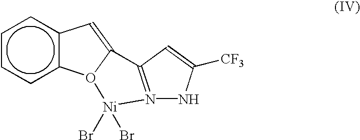

8. The catalyst according to claims 1 and 2 having the following formula:

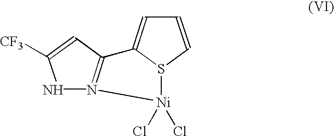

9. A process for the preparation of the catalyst according to at least one of the claims from 1 to 8, characterized by using a halide of an anhydrous metal (II) of Group VIII, diluting said halide in a suitable distilled solvent and adding a ligand having the general formula 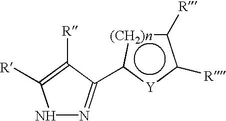
wherein
Y is selected from N, O and S
R′ and R″, the same or different, are selected from hydrogen, linear or branched alkyl, cycloalkyl and aryl groups, said groups, containing from 1 to 10 carbon atoms, being optionally halogenated,
R′″, R″″, the same or different, are selected from hydrogen and aryl groups or are bound together to form a condensed benzene ring, said aryl groups or said condensed benzene ring being optionally substituted with linear or branched alkyl groups containing from 1 to 10 carbon atoms,
n is an integer having the value of 1 or 2,
in an equivalent quantity with respect to the anhydrous metal, finally isolating the complex of the metal of Group VIII by filtration or by evaporation of the solvent and subsequent drying.

10. The catalyst according to claim 1, where, in the formula (2), the halogen is bromine.

11. The catalyst according to claim 1, where, in the formula (2), the linear or branched alkyl group is halogenated with fluorine.

12. The catalyst according to claim 1, where, in the formula (2), the aryl groups are optionally substituted with linear or branched alkyl groups containing from 1 to 10 carbon atoms.

13. The catalyst according to claims 1 and 2 having the following formula:

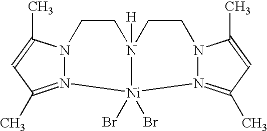

14. The catalyst according to claims 1 and 2 having the following formula:

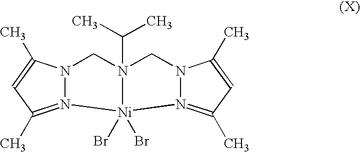

15. A process for the preparation of the catalyst according to at least one of the claims from 1 to 8, characterized by using a halide of an anhydrous metal (II) of Group VIII, diluting said halide in a suitable distilled solvent and adding a ligand having the general formula 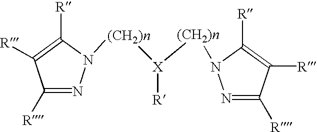
wherein:
X is selected from N, O and S
R′, R″, R′″, R″″, the same or different, are selected from hydrogen, linear or branched alkyl, cycloalkyl and aryl groups, said groups, containing from 1 to 10 carbon atoms, being optionally halogenated,
n is an integer ranging from 1 to 3,
in an equivalent quantity with respect to the anhydrous metal, finally isolating the complex of the metal of Group VIII by filtration or by evaporation of the solvent and subsequent drying.

16. The catalyst according to claim 1, where, in the formula (3), the halogen is bromine.

17. The catalyst according to claims 1 and 2 having the following formula:

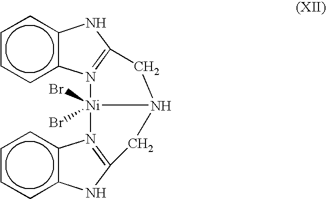

18. The catalyst according to claims 1 and 2 having the following formula:

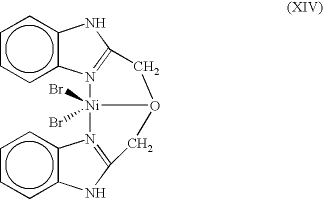

19. A process for the preparation of the catalyst according to at least one of the claims from 1 to 5 characterized by using a halide of an anhydrous metal (II) of Group VIII, diluting said halide in a suitable distilled solvent and adding a ligand having the general formula 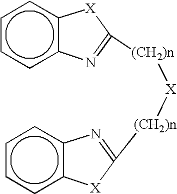
wherein:
X is selected from NH, O and S,
n is an integer ranging from 1 to 3.
in an equivalent quantity with respect to the anhydrous metal, finally isolating the complex of the metal of Group VIII by filtration or by evaporation of the solvent and subsequent drying.

20. A process for the polymerization of ethylene or the copolymerization of ethylene with another unsaturated monomer, characterized in that the catalyst according to at least one of claims 1 to 8 or 10 to 14 or 16 to 18 is used as polymerization catalyst.

21. The process according to claim 20, wherein the polymerization lymerization is carried out in an inert organic diluent, at a temperature ranging from 10 to 100° C. and at a pressure ranging from atmospheric pressure to 100 bars.

22. The process according to claim 20, characterized in that the unsaturated monomer is an alpha-olefin or a monomer of the acrylic or vinylic type.
